(19) United States
(12) Patent Application Publication
(10) Pub. No.: US 2018/0211506 A1
(43) Pub. Date: Jul. 26, 2018

(54) Shelter Usage Alert System

(71) Applicant: Robin Green, Oklahoma City, OK (US)

(72) Inventor: Robin Green, Oklahoma City, OK (US)

(21) Appl. No.: 15/412,658

(22) Filed: Jan. 23, 2017

(51) Int. Cl. G08B 21/18

(52) U.S. Cl. CPC G08B 21/18

(57) ABSTRACT

A shelter usage alter system includes a wall having an access opening positioned therein. A door is mounted on the wall and is positionable in a closed position or an open position. A locking mechanism is positioned on the door and is actuated from an interior of the shelter for selectively locking the door. The locking mechanism is actuated to a locked position or an unlocked position. A control circuit is operationally coupled to the locking mechanism and the control circuit receives a locked signal when the locking mechanism is in the locked position. A sound emitter is operationally coupled to the control circuit and is positioned outside of the shelter. The sound emitter emits an audible alarm sound when the control circuit receives the locked signal. The sound emitter is positioned adjacent to the shelter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to shelter occupation alerting devices and more particularly pertains to a new shelter occupation alerting device for signaling persons outside of a shelter that someone is locked within a shelter.

### BRIEF SUMMARY OF THE INVENTION

An embodiment of the disclosure meets the needs presented above by generally comprising a shelter including a wall having an access opening positioned therein. A door is mounted on the wall and is positionable in a closed position or an open position. A locking mechanism is positioned on the door and is actuated from an interior of the shelter for selectively locking the door. The locking mechanism is actuated to a locked position or an unlocked position. A control circuit is operationally coupled to the locking mechanism and the control circuit receives a locked signal when the locking mechanism is in the locked position. A sound emitter is operationally coupled to the control circuit and is positioned outside of the shelter. The sound emitter emits an audible alarm sound when the control circuit receives the locked signal. The sound emitter is positioned adjacent to the shelter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a housing for a shelter usage alter system according to an embodiment of the disclosure.

FIG. 2 is a back view of the housing of an embodiment of the disclosure.

FIG. 3 is a perspective view of an embodiment of the disclosure.

FIG. 4 is a schematic view of an embodiment of the disclosure.

### DETAILED DESCRIPTION OF THE INVENTION

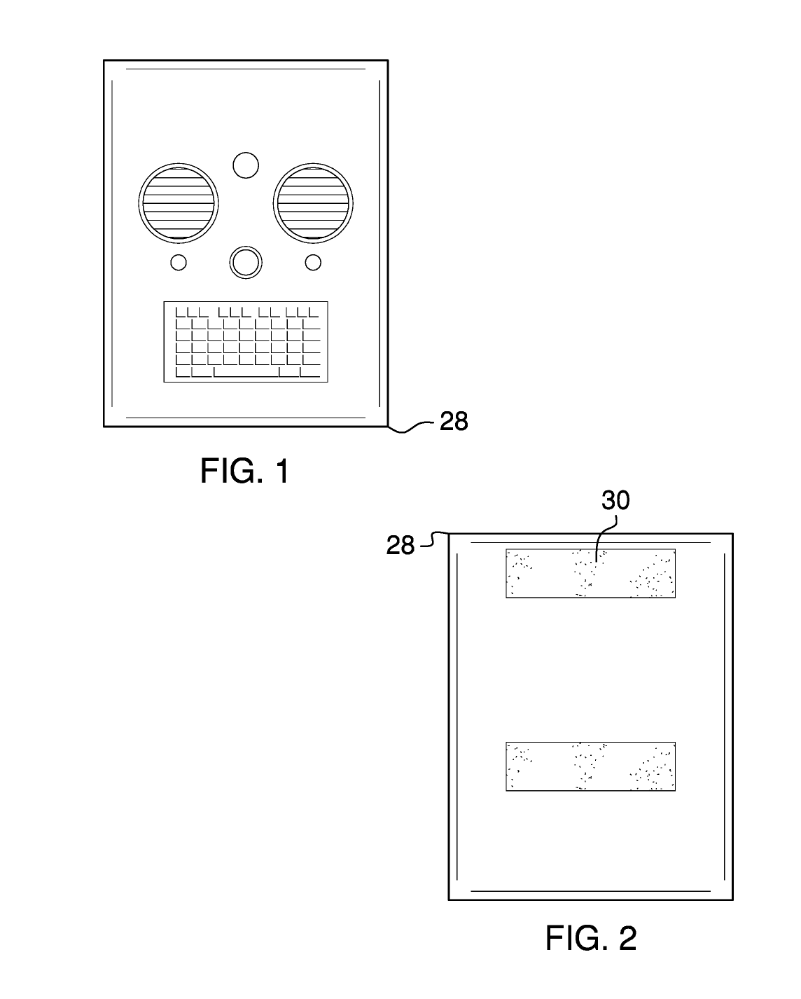

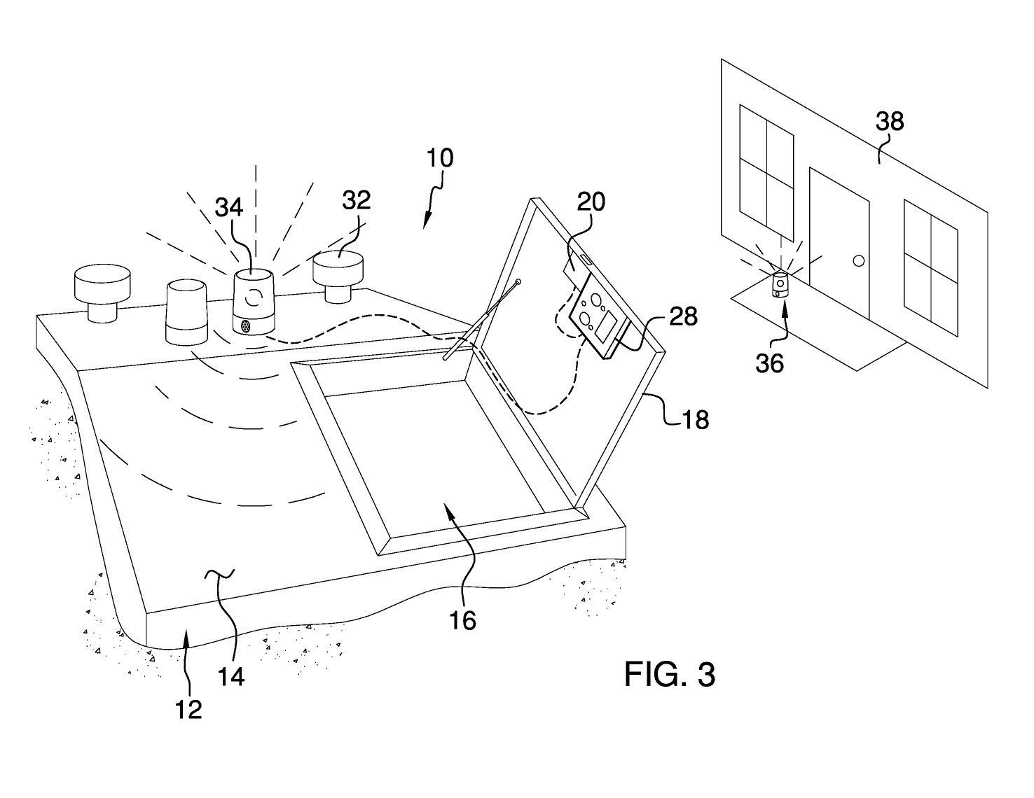

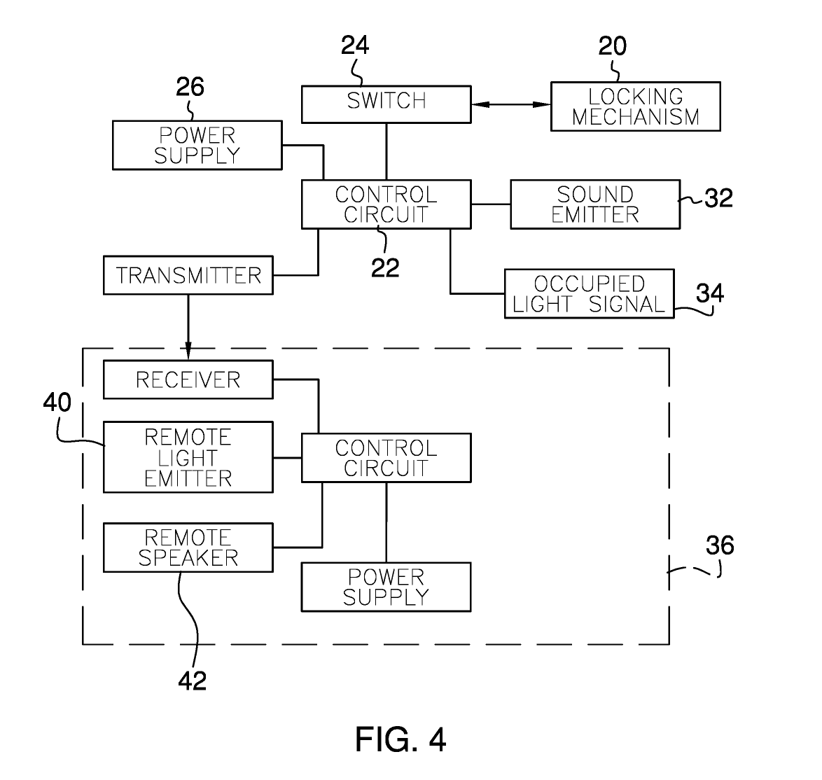

With reference now to the drawings, and in particular to FIGS. 1 through 4 thereof, a new shelter occupation alerting device embodying the principles and concepts of an embodiment of the disclosure and generally designated by the reference numeral 10 will be described.

As best illustrated in FIGS. 1 through 4, the shelter usage alter system 10 generally comprises a shelter 12 including a wall 14 that has an access opening 16 positioned therein. The shelter 12 may comprise any type of shelter used for security or for safety and therefore may include storm and bomb shelters typically found outside of a house or a dwelling or a safe room often located within a dwelling. A door 18 is mounted on the wall 14 and is positionable in a closed position or an open position. A locking mechanism 20 is positioned on the door 18 and is actuated from an interior of the shelter 12 for selectively locking the door 18. The locking mechanism 20 may be a conventional lock and is actuated to a locked position or an unlocked position.

A control circuit 22 is operationally coupled to the locking mechanism 20. This may be done in any conventional manner such as mounting a switch 24 within the locking mechanism 20, wherein the switch 24 is closed when the locking mechanism 20 is placed in the locked position. The control circuit 22 may be wirelessly or electrically coupled to the switch 24. A power supply 26, such as batteries or a hardwired power source, is electrically coupled to the control circuit 22. The control circuit 22 receives a locked signal when the locking mechanism 20 is in the locked position. The control circuit 22 may be mounted within a housing 28 that is mounted in the shelter 12 and may be mounted on the door 18 with adhesive 30. The control circuit 22 may include communication means such as a keypad, microphone, speaker and cellular and/or wifi connectivity to communicate with persons outside of the shelter 12.

A sound emitter 32 is operationally coupled to the control circuit 22 and is positioned outside of the shelter 12 and is positioned adjacent to the shelter 12. The term “adjacent” herein is defined as being mounted on the shelter 12 itself or within 25 feet of the door 18. The sound emitter 32 emits an audible alarm sound when the control circuit 22 receives the locked signal.

An occupied light signal 34 is mounted adjacent to the shelter 12 and is operationally coupled to the control circuit 22. The occupied light signal 34 emits light when the locked signal is received by the control circuit 22. The light emitted by the occupied light signal 34 may be colored and may also be a strobing light.

The system 10 may further include a remote alarm 36 that is in communication with the control circuit 22 and is positioned remotely of the shelter 12. The term “remotely” herein is defined to mean greater than 25 feet from the shelter 12 and if the shelter is positioned inside of a dwelling 38 the remote alarm 36 will be positioned outside of the dwelling 38. The remote alarm 36 emits an alert signal when the locked signal is received by the control circuit 22. The remote alarm 36 may be in wireless communication with the control circuit 22. The remote alarm 36 may include a remote light emitter 40 emitting light when the locked signal is received by the control circuit 22. The remote light emitter 40 may also emit a colored, strobing light. The remote alarm 36 may also or alternatively include a remote speaker 42 emitting an audible alarm sound when the locked signal is received by the control circuit 22.

In use, the control circuit 22 is generally in an off condition unless it receives the locked signal. Once the control circuit 22 receives the locked signal, the system 10 will begin to alert others with combinations of sound and light so that the persons outside of the shelter 12 will be alerted to people positioned within the shelter. The others will then be aware that someone may be in the shelter 12 and require assistance. Furthermore, the system 10 will alert adults should a child accidently become locked within the shelter 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An alarm and shelter system comprising:
a shelter configured for sheltering a human being within, said shelter including a wall having an access opening positioned therein, a door being mounted on said wall and being positionable in a closed position or an open position;
a locking mechanism being positioned on said door and being actuated from an interior of said shelter for selectively locking said door, said locking mechanism being actuated to a locked position or an unlocked position;
a control circuit being operationally coupled to said locking mechanism, said control circuit receiving a locked signal when said locking mechanism is in said locked position; and
a sound emitter being operationally coupled to said control circuit and being positioned outside of said shelter, said sound emitter emitting an audible alarm sound when said control circuit receives said locked signal, said sound emitter being positioned adjacent to said shelter.

2. The alarm and shelter system according to claim 1, further including an occupied light signal being mounted adjacent to said shelter and being operationally coupled to said control circuit, said occupied light signal emitting light when said locked signal is received by said control circuit.

3. The alarm and shelter system according to claim 1, further including a remote alarm being in communication with said control circuit and being positioned remotely of said shelter, said remote alarm emitting an alert signal when said locked signal is received by said control circuit.

4. The alarm and shelter system according to claim 3, wherein said remote alarm is in wireless communication with said control circuit.

5. The alarm and shelter system according to claim 3, wherein said remote alarm includes a remote light emitter emitting light when said locked signal is received by said control circuit.

6. The alarm and shelter system according to claim 5, wherein said remote alarm includes a remote speaker emitting an audible alarm sound when said locked signal is received by said control circuit.

7. The alarm and shelter system according to claim 3, wherein said remote alarm includes a remote speaker emitting an audible alarm sound when said locked signal is received by said control circuit.

8. The alarm and shelter system according to claim 6, further including an occupied light signal being mounted adjacent to said shelter and being operationally coupled to said control circuit, said occupied light signal emitting light when said locked signal is received by said control circuit.

9. An alarm and shelter system comprising:
a shelter configured for sheltering a human being within, said shelter including a wall having an access opening positioned therein, a door being mounted on said wall and being positionable in a closed position or an open position;
a locking mechanism being positioned on said door and being actuated from an interior of said shelter for selectively locking said door, said locking mechanism being actuated to a locked position or an unlocked position;
a control circuit being operationally coupled to said locking mechanism, said control circuit receiving a locked signal when said locking mechanism is in said locked position;
a sound emitter being operationally coupled to said control circuit and being positioned outside of said shelter, said sound emitter emitting an audible alarm sound when said control circuit receives said locked signal, said sound emitter being positioned adjacent to said shelter;
an occupied light signal being mounted adjacent to said shelter and being operationally coupled to said control circuit, said occupied light signal emitting light when said locked signal is received by said control circuit;
a remote alarm being in communication with said control circuit and being positioned remotely of said shelter, said remote alarm emitting an alert signal when said locked signal is received by said control circuit, said remote alarm being in wireless communication with said control circuit, said remote alarm including:
a remote light emitter emitting light when said locked signal is received by said control circuit; and
a remote speaker emitting an audible alarm sound when said locked signal is received by said control circuit.
